(19) United States
(12) Patent Application Publication
(10) Pub. No.: US 2015/0071081 A1
(43) Pub. Date: Mar. 12, 2015

(54) APPARATUSES AND METHODS FOR UPLINK POWER CONTROL IN WIRELESS COMMUNICATION

(71) Applicant: QUALCOMM Incorporated, San Diego, CA (US)

(72) Inventors: Abhinav Gupta, San Jose, CA (US); Nate Chizgi, Sunnyvale, CA (US); Sitaramanjaneyulu Kanamarlapudi, San Diego, CA (US); Chih-Ping Hsu, San Diego, CA (US); Nitin Kasturi, Saratoga, CA (US)

(73) Assignee: QUALCOMM Incorporated, San Diego, CA (US)

(21) Appl. No.: 14/243,205

(22) Filed: Apr. 2, 2014

Related U.S. Application Data
(60) Provisional application No. 61/876,461, filed on Sep. 11, 2013.
(60) Provisional application No. 61/885,382, filed on Oct. 1, 2013.

(51) Int. Cl. H04W 52/14

(52) U.S. Cl. CPC H04W 52/146
USPC 370/241; 370/329

(57) ABSTRACT

Aspects of the disclosure provide techniques for improving uplink transmit power control at a user equipment (UE). When the UE is communicating with multiple cells using Multi-flow High-Speed Downlink Packet Access (MF-HSDPA), the UE may control its uplink power based on an improved MF-HSDPA uplink power control algorithm, which is different from an or-of-downs (OOD) transmit power control. In handover, a UE may determine its transmit power to be less than a transmit power requested by a high-speed cell and more than an OOD transmit power.

### CROSS-REFERENCE TO RELATED APPLICATIONS

This application claims priority to and the benefit of provisional patent application No. 61/885,382 filed in the United States Patent Office on 1 Oct. 2013, and provisional patent application no. 61/876,461 filed in the United States Patent Office on 11 Sep. 2013, the entire content of both applications are incorporated herein by reference.

### TECHNICAL FIELD

Aspects of the present disclosure relate generally to wireless communication systems, and more particularly, uplink transmit power control at a wireless communication device.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). UMTS also supports enhanced 3G data communications protocols, such as High Speed Packet Access (HSPA), which provides higher data transfer speeds and capacity to associated UMTS networks.

In a UMTS network, a fractional dedicated physical channel (F-DPCH) is used to improve soft handover by allowing the multiplexing of transmit power control (TPC) commands on the downlink. In F-DPCH, when signaling radio bearers (SRBs) are transmitted over a high speed (HS) cell, it is important to demodulate these SRBs successfully and to indicate an ACK (acknowledgement response) on the uplink back to the network to close the loop.

High Speed Downlink Packet Access (HSDPA) is the downlink enhancement included in HSPA and is designed to increase downlink packet data throughput by means of fast physical layer (L1) retransmission and transmission combining, as well as fast link adaptation controlled by a Node B. An enhancement of HSDPA networks is a multi-cell transmission scheme called Multi-flow HSDPA (MF-HSDPA). In MF-HSDPA, downlink data (flow) is transmitted to the UE at an area served by two neighboring cells from one or both of the cells. Therefore, the UE may receive multiple data flows from the MF cells, thus providing increased diversity and throughput. In MF-HSDPA, if there is any significant imbalance between the uplink power desired by the high speed links to different cells, the network might not be able to decode the feedback signal reliably from the weaker uplink under the typical power control scheme such as the OOD power control scheme.

As the demand for mobile broadband access continues to increase, research and development continue to advance the UMTS technologies not only to meet the growing demand for mobile broadband access, but to advance and enhance the user experience with mobile communications such as improved uplink transmit power control.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the disclosure provide a number of techniques to improve uplink transmit power control at a user equipment. When a user equipment (UE) is communicating with multiple cells using Multi-flow High-Speed Downlink Packet Access (MF-HSDPA), the UE may control its uplink power based on an improved MF-HSDPA uplink power control algorithm, which is different from an or-of-downs (OOD) transmit power control. In handover, a UE may determine its transmit power to be less than a transmit power requested by a high-speed cell and more than an OOD transmit power.

In one aspect, the disclosure provides a method of controlling uplink power of a UE in a wireless communication system. The UE communicates with a first cell and a second cell using Multi-flow High-Speed Downlink Packet Access (MF-HSDPA). The UE receives a first downlink dedicated physical control channel (DPCCH) from the first cell and a second downlink DPCCH from the second cell. If high speed (HS) downlink data is scheduled for the UE from at least one of the first cell or second cell, the UE performs a MF-HSDPA uplink power control algorithm in which if a transmit power control (TPC) command of the first or second downlink DPCCHs requests the UE to increase uplink power, the UE increases its transmit power.

Another aspect of the disclosure provides a method of controlling uplink power of a UE during soft handover between a high speed (HS) cell and a non-HS cell in a wireless communication system. The UE receives one or more transmit power control (TPC) commands from the HS cell and non-HS cell. The UE determines an or-of-downs (OOD) transmit power based on the one or more TPC commands. The UE determines an imbalance condition in soft handover based on the one or more TPC commands. If the imbalance condition exists, the UE determines a transmit power that is less than a transmit power requested by the HS cell and more than the OOD transmit power.

Another aspect of the disclosure provides an apparatus for wireless communication. The apparatus includes at least one processor, a communication interface coupled to the at least one processor, and a memory coupled to the at least one processor. The at least one processor includes a number of components including first through third components. The first component is configured to communicate with a first cell and a second cell using Multi-flow High-Speed Downlink Packet Access (MF-HSDPA). The second component is configured to receive a first downlink dedicated physical control channel (DPCCH) from the first cell and a second downlink DPCCH from the second cell. The third component is configured to if high speed (HS) downlink data is scheduled for the apparatus from at least one of the first cell or second cell, perform a MF-HSDPA uplink power control algorithm in which if a transmit power control (TPC) command of the first or second downlink DPCCHs requests the apparatus to increase uplink power, the apparatus increases its transmit power.

Another aspect of the disclosure provides an apparatus for wireless communication. The apparatus includes at least one processor, a communication interface coupled to the at least one processor, and a memory coupled to the at least one processor. The at least one processor includes a number of components including first through third components. The first component is configured to determine an or-of-downs (OOD) transmit power based on one or more transmit power control (TPC) commands received from a high speed (HS) cell and a non-HS cell. The second component is configured to determine an imbalance condition in soft handover between the HS cell and non-HS cell based on the one or more TPC commands. The third component is configured to if the imbalance condition exists, determine a transmit power of the apparatus that is less than a transmit power requested by the HS cell and more than the OOD transmit power.

Another aspect of the disclosure provides an apparatus for wireless communication. The apparatus includes means for communicating with a first cell and a second cell using Multi-flow High-Speed Downlink Packet Access (MF-HSDPA); means for receiving a first downlink dedicated physical control channel (DPCCH) from the first cell; means for receiving a second downlink DPCCH from the second cell; and means for if high speed (HS) downlink data is scheduled for the apparatus from at least one of the first cell or second cell, performing a MF-HSDPA uplink power control algorithm in which if a transmit power control (TPC) command of the first or second downlink DPCCHs requests the apparatus to increase uplink power, the apparatus increases the transmit power of the apparatus.

Another aspect of the disclosure provides a computer-readable storage medium including code for controlling uplink power of an UE in a wireless communication system. The code causes the UE to communicate with a first cell and a second cell using MF-HSDPA. The code further causes the UE to receive a first downlink DPCCH from the first cell. The code further causes the UE to receive a second downlink DPCCH from the second cell. If HS downlink data is scheduled for the UE from at least one of the first cell or second cell, the code causes the UE to perform a MF-HSDPA uplink power control algorithm in which if a TPC command of the first or second downlink DPCCHs requests the UE to increase uplink power, the UE increases the transmit power of the UE.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram illustrating an example of a hardware implementation for an apparatus employing a processing system.

FIG. 2 is a block diagram conceptually illustrating an example of a telecommunications system.

FIG. 3 is a conceptual diagram illustrating an example of a radio protocol architecture for the user and control plane.

FIG. 4 is a conceptual diagram illustrating an example of an access network.

FIG. 5 is a flowchart illustrating a method for uplink transmit power determination in soft handover between a high speed (HS) cell and a non-HS cell in accordance with an aspect of the disclosure.

FIG. 6 is a conceptual diagram illustrating a user equipment configured to perform uplink transmit power determination in soft handover between an HS cell and a non-HS cell, and in Multi-flow High-Speed Downlink Packet Access (MF-HSDPA) in accordance with an aspect of the disclosure.

FIG. 7 is a conceptual diagram illustrating an exemplary system for MF-HSDPA in accordance with some aspects of the present disclosure.

FIG. 8 is a simplified block diagram illustrating some components of an exemplary transceiver for use in a MF-HSDPA network in accordance with some aspects of the present disclosure.

FIG. 9 is a schematic illustration comparing downlink paths in an HSDPA network and a MF-HSDPA network.

FIG. 10 is a conceptual block diagram illustrating an example of a Node B in communication with a UE in a telecommunications system.

FIG. 11 is a conceptual diagram illustrating a dedicated physical data channel (DPDCH), a dedicated physical control channel (DPCCH) of a downlink DPCH, a high-speed shared control channel (HS-SCCH), and a fractional DPCH (F-DPCH).

FIG. 12 is a flowchart illustrating a power control method for controlling uplink power at a user equipment in a MF-HSDPA network in accordance with an aspect of the disclosure.

FIGS. 13 and 14 are flowcharts illustrating a MF-HSDPA uplink power control algorithm in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the disclosure are directed to uplink power control at a user equipment (UE) in a wireless communication network. In some soft handover situations, the uplink power level of the UE may be driven or dominated by a non-HS cell (e.g., UMTS Release 99 cell) due to an or-of-downs (OOD) power control scheme used to minimize UE transmit power, which in turn may cause the HS cell to have trouble receiving the UE ACK reliably. In the OOD power control scheme, the UE reduces its transmit power if the UE receives a power down command from any cell/sector in the Active Set. As such, there may be repeated retransmissions of the SRBs, leading to large delays in signaling message reception and an increase in dropped calls. For non-SRB packets, this can also lead to a substantial decrease in HS data throughput due to unnecessary retransmissions.

In some aspects of the disclosure, a user equipment such as a mobile terminal may communicate with a first cell and a second cell using Multi-flow High-Speed Downlink Packet Access (MF-HSDPA). Under certain conditions, if the UE receives a transmit power control (TPC) command that requests an uplink power increase, the UE increases its transmit power. In some aspects of the disclosure, a user equipment during soft handover between a high speed (HS) cell and a non-HS cell determines a transmit power that is between a transmit power requested by the HS cell and a transmit power determined by an or-of-downs (OOD) approach, which will be described in detail below.

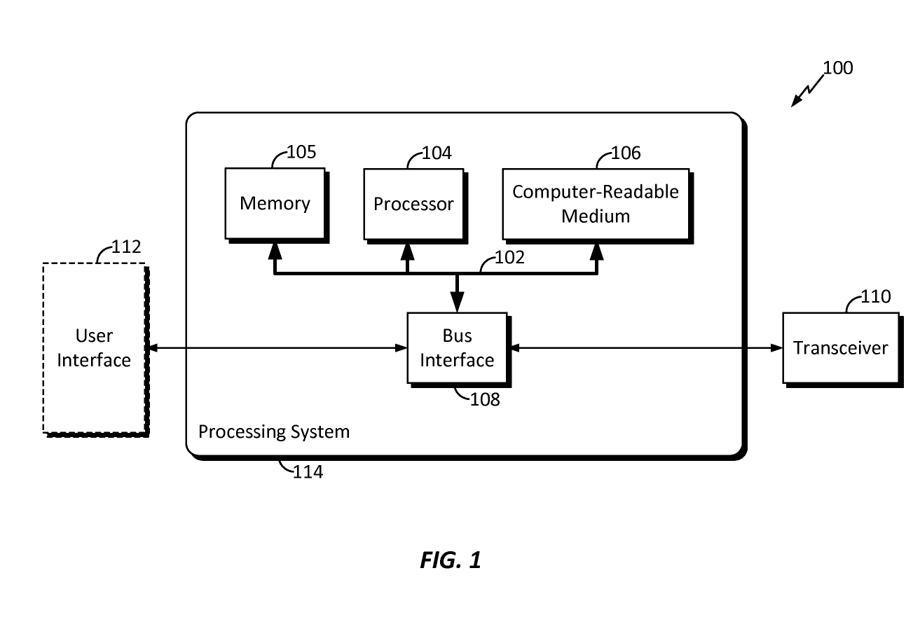

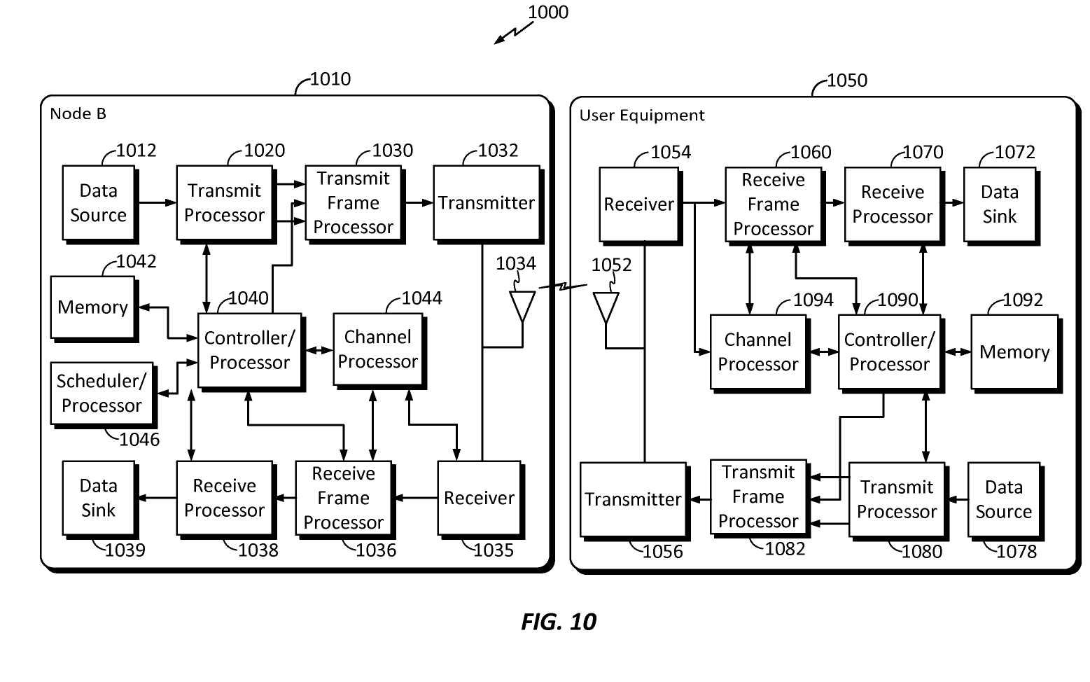

FIG. 1 is a conceptual diagram illustrating an example of a hardware implementation for an apparatus 100 employing a processing system 114. In accordance with various aspects of the disclosure, an element, or any portion of an element, or any combination of elements may be implemented with a processing system 114 that includes one or more processors 104. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure in FIGS. 10-12.

In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors (represented generally by the processor 104), a memory 105, and computer-readable media (represented generally by the computer-readable medium 106). The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. In various aspect of the disclosure, the transceiver 110 may include one or more transmitters and one or more receivers. The transmitters and receivers may be a unitary unit or separate units. Depending upon the nature of the apparatus, a user interface 112 (e.g., keypad, display, speaker, microphone, joystick, touchpad, touchscreen) may also be provided.

The processor 104 is responsible for managing the bus 102 and general processing, including the execution of software stored on the computer-readable medium 106. The software, when executed by the processor 104, causes the processing system 114 to perform the various functions described in FIGS. 10-12 for any particular apparatus. The computer-readable medium 106 may also be used for storing data that is manipulated by the processor 104 when executing software.

One or more processors 104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 106 may reside in the processing system 114, external to the processing system 114, or distributed across multiple entities including the processing system 114. The computer-readable medium 106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

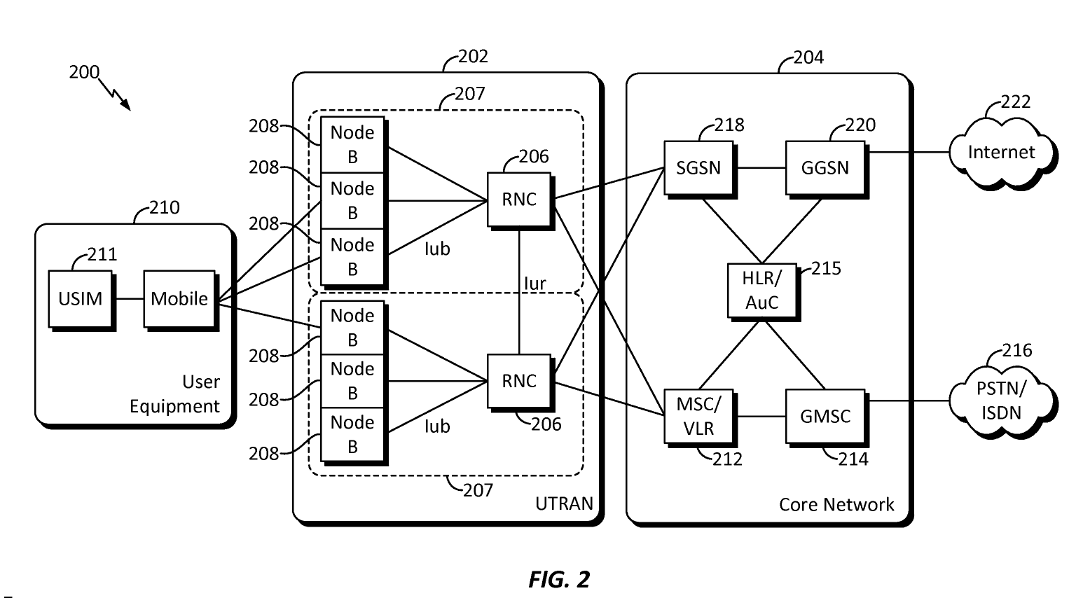

The various concepts presented throughout this disclosure may be implemented across a broad variety of telecommunication systems, network architectures, and communication standards. Referring now to FIG. 2, as an illustrative example without limitation, various aspects of the present disclosure are illustrated with reference to a Universal Mobile Telecommunications System (UMTS) system 200. A UMTS network includes three interacting domains: a core network 204, a radio access network (RAN) (e.g., the UMTS Terrestrial Radio Access Network (UTRAN) 202), and a user equipment (UE) 210. Among several options available for a UTRAN 202, in this example, the illustrated UTRAN 202 may employ a W-CDMA air interface for enabling various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the illustrated RNCs 206 and RNSs 207. The RNC 206 is an apparatus responsible for, among other things, assigning, reconfiguring, and releasing radio resources within the RNS 207. The RNC 206 may be interconnected to other RNCs (not shown) in the UTRAN 202 through various types of interfaces such as a direct physical connection, a virtual network, or the like using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a core network 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210 and the uplink (UL), also called the reverse link, refers to the communication link from a UE 210 to a Node B 208.

The core network 204 can interface with one or more access networks, such as the UTRAN 202. As shown, the core network 204 is a UMTS core network. However, as those skilled in the art will recognize, the various concepts presented throughout this disclosure may be implemented in a RAN, or other suitable access network, to provide UEs with access to types of core networks other than UMTS networks.

The illustrated UMTS core network 204 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The illustrated core network 204 also supports packet-switched data services with a serving GPRS support node (SGSN) 218 and a gateway GPRS support node (GGSN) 220. General Packet Radio Service (GPRS) is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

In a wireless telecommunication system, the communication protocol architecture may take on various forms depending on the particular application. For example, in a 3GPP UMTS system 200, the signaling protocol stack is divided into a Non-Access Stratum (NAS) and an Access Stratum (AS). The NAS provides the upper layers, for signaling between the UE 210 and the core network 204 (referring to FIG. 2), and may include circuit switched and packet switched protocols. The AS provides the lower layers, for signaling between the UTRAN 202 and the UE 210, and may include a user plane and a control plane. Here, the user plane or data plane carries user traffic, while the control plane carries control information (i.e., signaling).

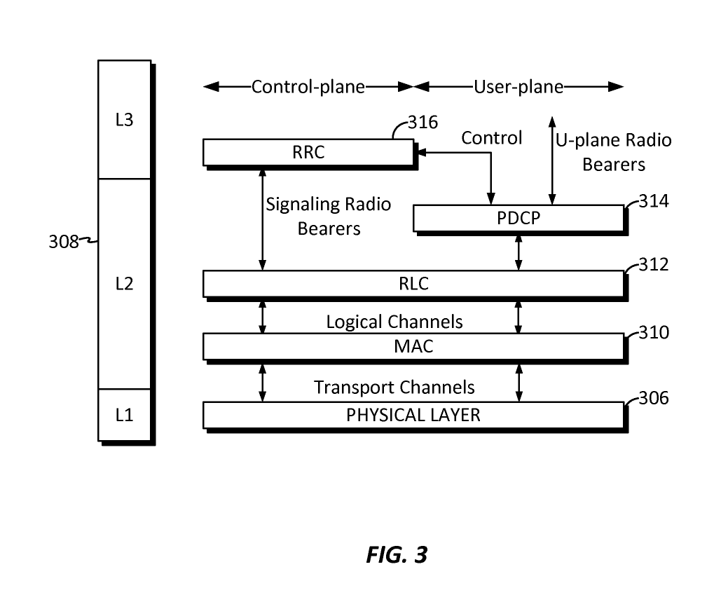

Turning to FIG. 3, the AS is shown with three layers: Layer 1, Layer 2, and Layer 3. Layer 1 is the lowest layer and implements various physical layer signal processing functions. Layer 1 will be referred to herein as the physical layer 306. The data link layer, called Layer 2 308, is above the physical layer 306 and is responsible for the link between the UE 210 and Node B 208 over the physical layer 306.

At Layer 3, the RRC layer 316 handles the control plane signaling between the UE 210 and the Node B 208. RRC layer 316 includes a number of functional entities for routing higher layer messages, handling broadcasting and paging functions, establishing and configuring radio bearers, etc.

In the illustrated air interface, the L2 layer 308 is split into sublayers. In the control plane, the L2 layer 308 includes two sublayers: a medium access control (MAC) sublayer 310 and a radio link control (RLC) sublayer 312. In the user plane, the L2 layer 308 additionally includes a packet data convergence protocol (PDCP) sublayer 314. Although not shown, the UE may have several upper layers above the L2 layer 308 including a network layer (e.g., IP layer) that is terminated at a PDN gateway on the network side and an application layer that is terminated at the other end of the connection (e.g., far end UE, server, etc.).

The PDCP sublayer 314 provides multiplexing between different radio bearers and logical channels. The PDCP sublayer 314 also provides header compression for upper layer data packets to reduce radio transmission overhead, security by ciphering the data packets, and handover support for UEs between Node Bs.

The RLC sublayer 312 generally supports an acknowledged mode (AM) (where an acknowledgment and retransmission process may be used for error correction), an unacknowledged mode (UM), and a transparent mode for data transfers, and provides segmentation and reassembly of upper layer data packets and reordering of data packets to compensate for out-of-order reception due to a hybrid automatic repeat request (HARQ) at the MAC layer. In the acknowledged mode, RLC peer entities such as an RNC and a UE may exchange various RLC protocol data units (PDUs) including RLC Data PDUs, RLC Status PDUs, and RLC Reset PDUs, among others. In the present disclosure, the term “packet” may refer to any RLC PDU exchanged between RLC peer entities.

The MAC sublayer 310 provides multiplexing between logical and transport channels. The MAC sublayer 310 is also responsible for allocating the various radio resources (e.g., resource blocks) in one cell among the UEs. The MAC sublayer 310 is also responsible for HARQ operations. The MAC sublayer 310 includes various MAC entities, including but not limited to a MAC-d entity and MAC-hs/ehs entity. The Radio Network Controller (RNC) houses protocol layers from MAC-d and above. For the high speed channels, the MAC-hs/ehs layer is housed in the Node B.

From the UE side, The MAC-d entity is configured to control access to all the dedicated transport channels, to a MAC-c/sh/m entity, and to the MAC-hs/ehs entity. Further, from the UE side, the MAC-hs/ehs entity is configured to handle the HSDPA specific functions and control access to the HS-DSCH transport channel. Upper layers configure which of the two entities, MAC-hs or MAC-ehs, is to be applied to handle HS-DSCH functionality.

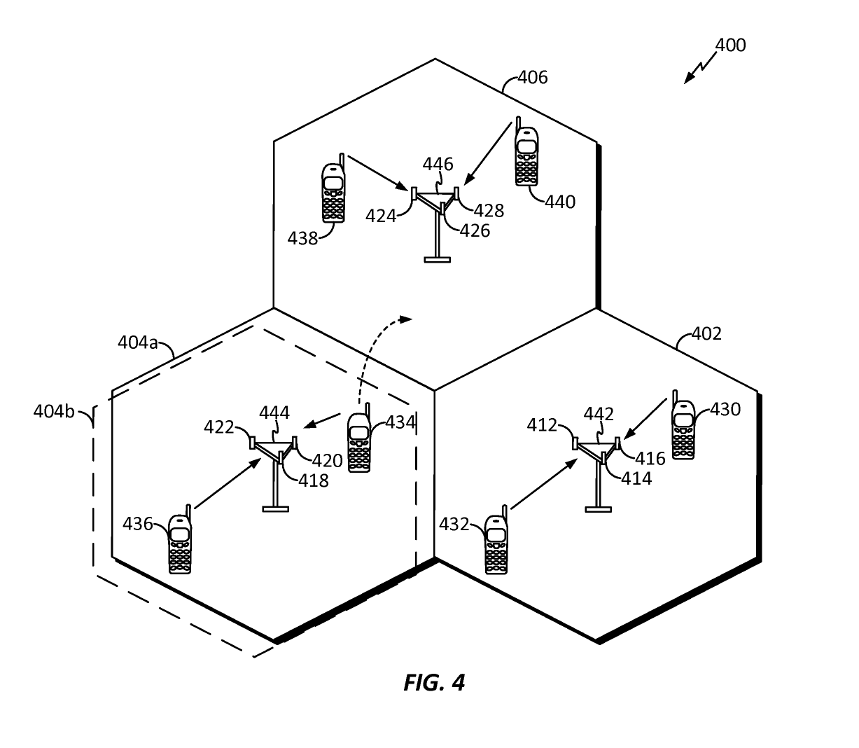

The UTRAN 202 is one example of a RAN that may be utilized in accordance with the present disclosure. Referring to FIG. 4, by way of example and without limitation, a simplified schematic illustration of a RAN 400 in a UTRAN architecture is illustrated. The system includes multiple cellular regions (cells), including cells 402, 404, and 406, each of which may include one or more sectors. Cells may be defined geographically (e.g., by coverage area) and/or may be defined in accordance with a frequency, scrambling code, etc. That is, the illustrated geographically-defined cells 402, 404, and 406 may each be further divided into a plurality of cells, e.g., by utilizing different scrambling codes. For example, cell 404a may utilize a first scrambling code, and cell 404b, while in the same geographic region and served by the same Node B 444, may be distinguished by utilizing a second scrambling code.

In a cell that is divided into sectors, the multiple sectors within a cell can be formed by groups of antennas with each antenna responsible for communication with UEs in a portion of the cell. For example, in cell 402, antenna groups 412, 414, and 416 may each correspond to a different sector. In cell 404, antenna groups 418, 420, and 422 may each correspond to a different sector. In cell 406, antenna groups 424, 426, and 428 may each correspond to a different sector.

The cells 402, 404, and 406 may include several UEs that may be in communication with one or more sectors of each cell 402, 404, or 406. For example, UEs 430 and 432 may be in communication with Node B 442, UEs 434 and 436 may be in communication with Node B 444, and UEs 438 and 440 may be in communication with Node B 446. Here, each Node B 442, 444, and 446 may be configured to provide an access point to a core network 204 (see FIG. 2) for all the UEs 430, 432, 434, 436, 438, and 440 in the respective cells 402, 404, and 406. Any of the cells illustrated in FIG. 4 may be a high speed (HS) cell that supports HSPA, HSDPA, HSUPA, or Long Term Evolution.

During a call with a source cell, or at any other time, the UE 436 may monitor various parameters of the source cell as well as various parameters of neighboring cells. Further, depending on the quality of these parameters, the UE 436 may maintain communication with one or more of the neighboring cells. During this time, the UE 436 may maintain an Active Set, that is, a list of cells to which the UE 436 is simultaneously connected (i.e., the UTRAN cells that are currently assigning a downlink dedicated physical channel (DPCH) or fractional downlink dedicated physical channel F-DPCH to the UE 436 may constitute the Active Set).

Referring back to FIG. 2, the UTRAN air interface may be a spread spectrum Direct-Sequence Code Division Multiple Access (DS-CDMA) system, such as one utilizing the W-CDMA standards. The spread spectrum DS-CDMA spreads user data through multiplication by a sequence of pseudorandom bits called chips. The W-CDMA air interface for the UTRAN 202 is based on such DS-CDMA technology and additionally calls for a frequency division duplexing (FDD). FDD uses a different carrier frequency for the uplink (UL) and downlink (DL) between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface or any other suitable air interface.

A high speed packet access (HSPA) air interface includes a series of enhancements to the 3G/W-CDMA air interface between the UE 210 and the UTRAN 202, facilitating greater throughput and reduced latency for users. Among other modifications over prior standards, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink or EUL).

For example, in Release 5 of the 3GPP family of standards, HSDPA was introduced. HSDPA utilizes as its transport channel the high-speed downlink shared channel (HS-DSCH), which may be shared by several UEs. The HS-DSCH is implemented by three physical channels: the high-speed physical downlink shared channel (HS-PDSCH), the high-speed shared control channel (HS-SCCH), and the high-speed dedicated physical control channel (HS-DPCCH).

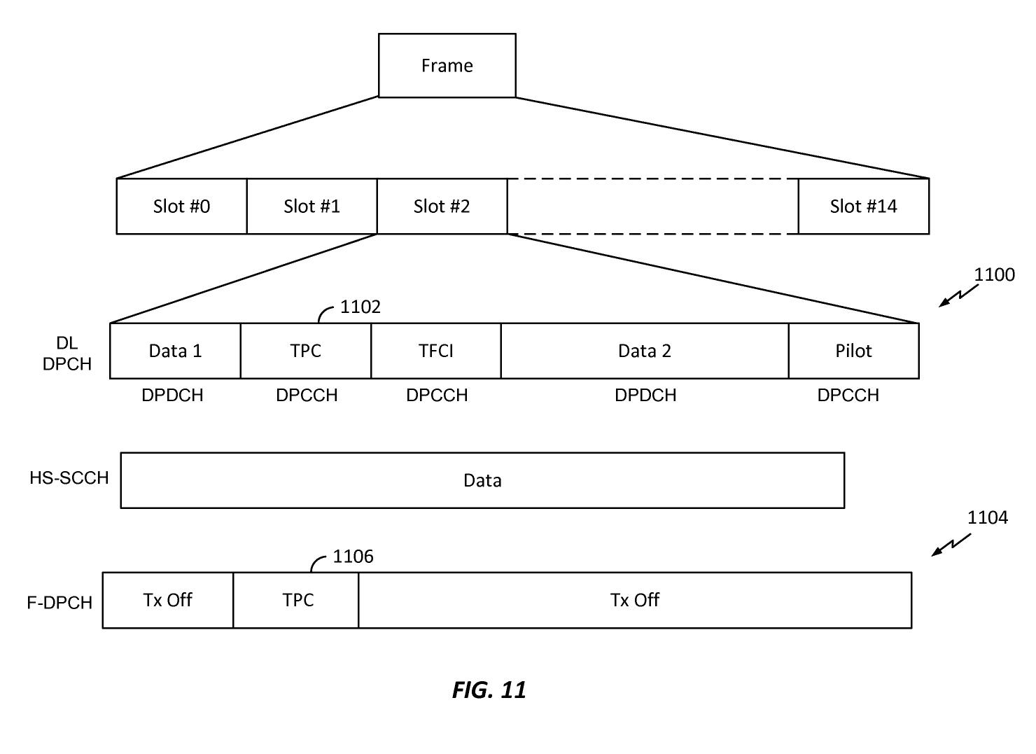

The HS-SCCH is a physical channel that may be utilized to carry downlink control information related to the transmission of HS-DSCH (see FIG. 11). Here, the HS-DSCH may be associated with one or more HS-SCCH. The UE may continuously monitor the HS-SCCH to determine when to read its data from the HS-DSCH and to determine the modulation scheme used on the assigned physical channel.

The HS-PDSCH is a physical channel that may be shared by several UEs and may carry downlink data for the high-speed downlink. The HS-PDSCH may support quadrature phase shift keying (QPSK), 16-quadrature amplitude modulation (16-QAM), and multi-code transmission.

The HS-DPCCH is an uplink physical channel that may carry feedback from the UE to assist the Node B in its scheduling algorithm. The feedback may include a channel quality indicator (CQI) and a positive or negative acknowledgement (ACK/NAK) of a previous HS-DSCH transmission.

One difference on the downlink between Release-5 HSDPA and the previously standardized circuit-switched air-interface is the absence of soft handover in HSDPA. This means that HSDPA channels are transmitted to the UE from a single cell called the HSDPA serving cell. As the user moves, or as one cell becomes preferable to another, the HSDPA serving cell may change. Still, the UE may be in soft handover on the associated DPCH, receiving the same information from plural cells.

Aspects of the disclosure provide an apparatus and method for controlling uplink power at a UE. However, the disclosure is not limited to uplink power control and may be applicable in downlink power control. During soft handover, a UE may listen only to the power control commands from cells on the same Node B as the high-speed (HS) cell for some periods of time, and may listen to all cell power control commands for some other periods of time. With this approach, however, when the UE is listening only to the HS cell, it may be using more transmit power than the other non-HS cells may desire, which may negatively impact the other UEs in the system.

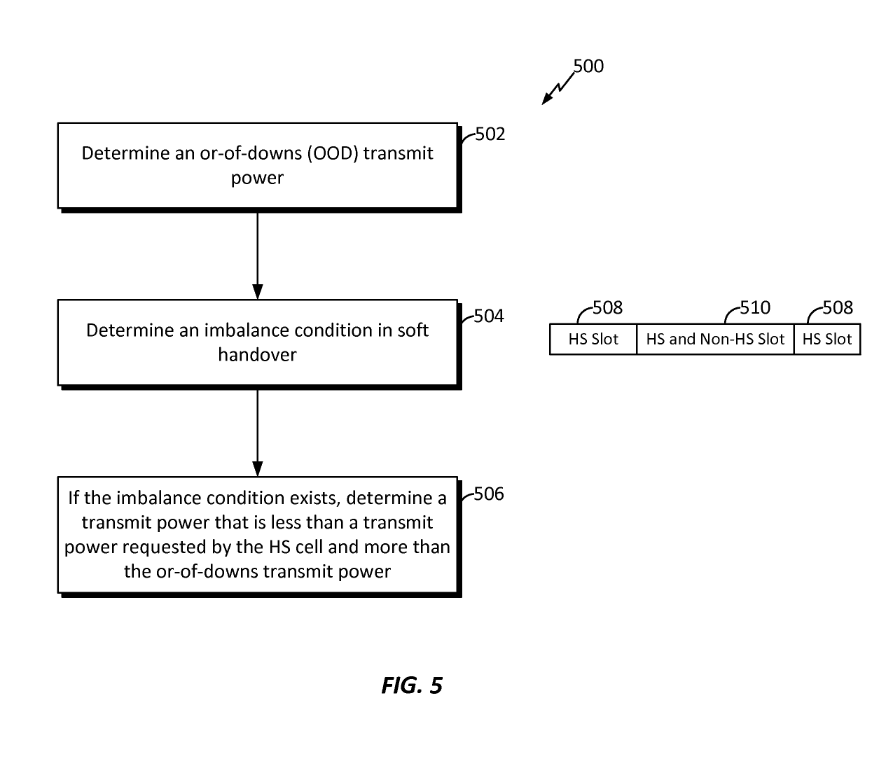

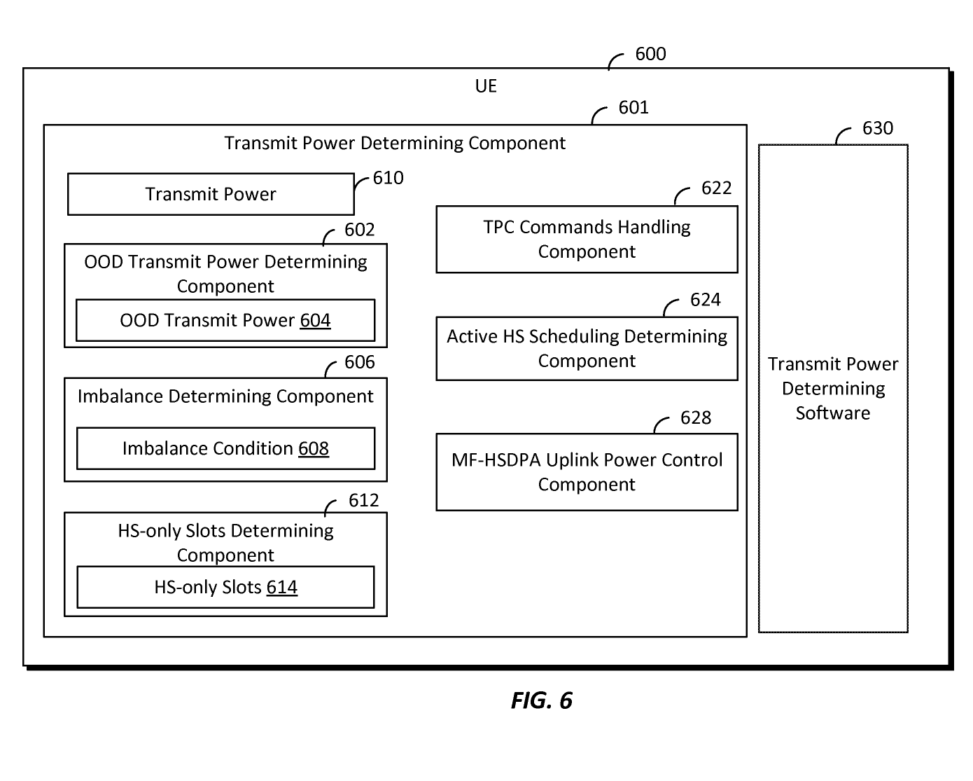

FIG. 5 is a flowchart illustrating a method 500 for uplink transmit power determination in soft handover between a HS cell and a non-HS cell in accordance with an aspect of the disclosure. By way of example and not limitation, the method 500 may be performed by a UE 600 including a transmit power determining component 601 as illustrated in FIG. 6 in accordance with an aspect of the disclosure. The UE 600 may be any of the UEs illustrated in FIGS. 2, 4, 7, and 10, which may be implemented using the apparatus 100 of FIG. 1. It should be understood that in other implementations, other systems and/or UEs, Node Bs, or other apparatus including different components than those illustrated in FIGS. 1, 2, 4, 6, 7, and 10 may be used to implement the method 500 of FIG. 5. At block 502, a UE determines an or-of-downs (OOD) transmit power based on one or more TPC commands (e.g., up or down TPC commands) received from an HS cell and one or more non-HS cells. For example, in an aspect of the disclosure, an OOD transmit power determining component 602 (see FIG. 6) determines OOD transmit power 604 based on TPC commands received from an HS cell and/or non-HS cells (e.g., cells 402, 404, or 406 in FIG. 4).

At block 504, the UE determines the presence of an imbalance condition in soft handover based on the one or more TPC commands. For example, in an aspect of the disclosure, an imbalance determining component 606 (see FIG. 6) determines an imbalance condition 608 in soft handover among the HS cell and non-HS cells based on TPC commands (e.g., up or down TPC commands) received from the HS cell and non-HS cells. In some aspects of the disclosure, the imbalance condition 608 may be determined to be present when the uplink transmit power is driven by at least one non-HS cell according to the OOD transmit power 604. For example, a non-HS cell may be transmitting the down TPC command, and the HS cell may be transmitting the up TPC command. In accordance with OOD control, the UE reduces its transmit power and may cause the problem that the HS cell may not receive the HS feedback at sufficient power level.

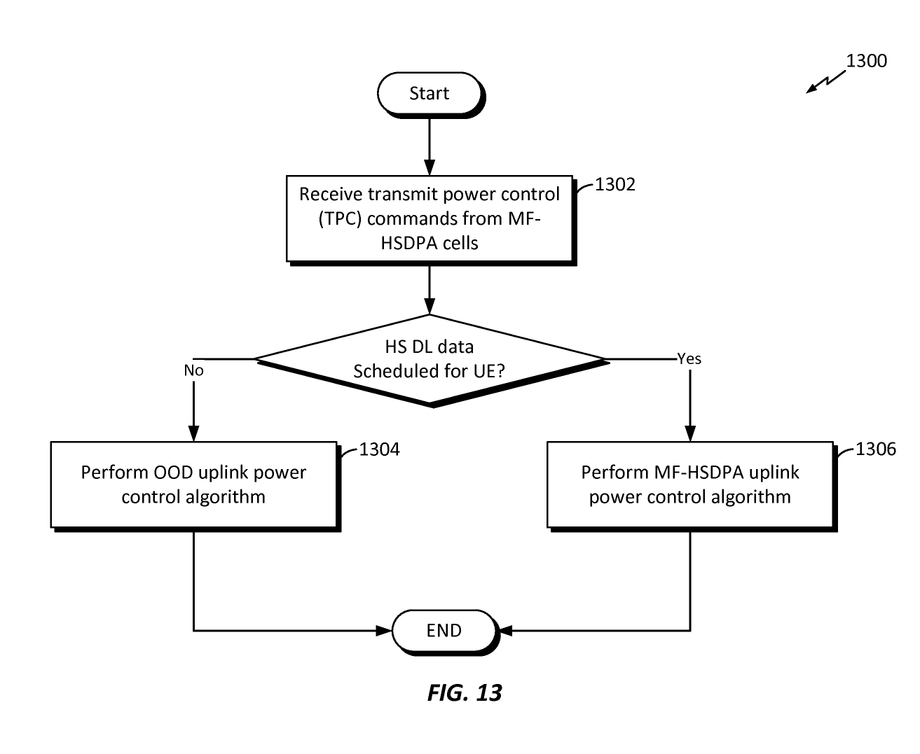

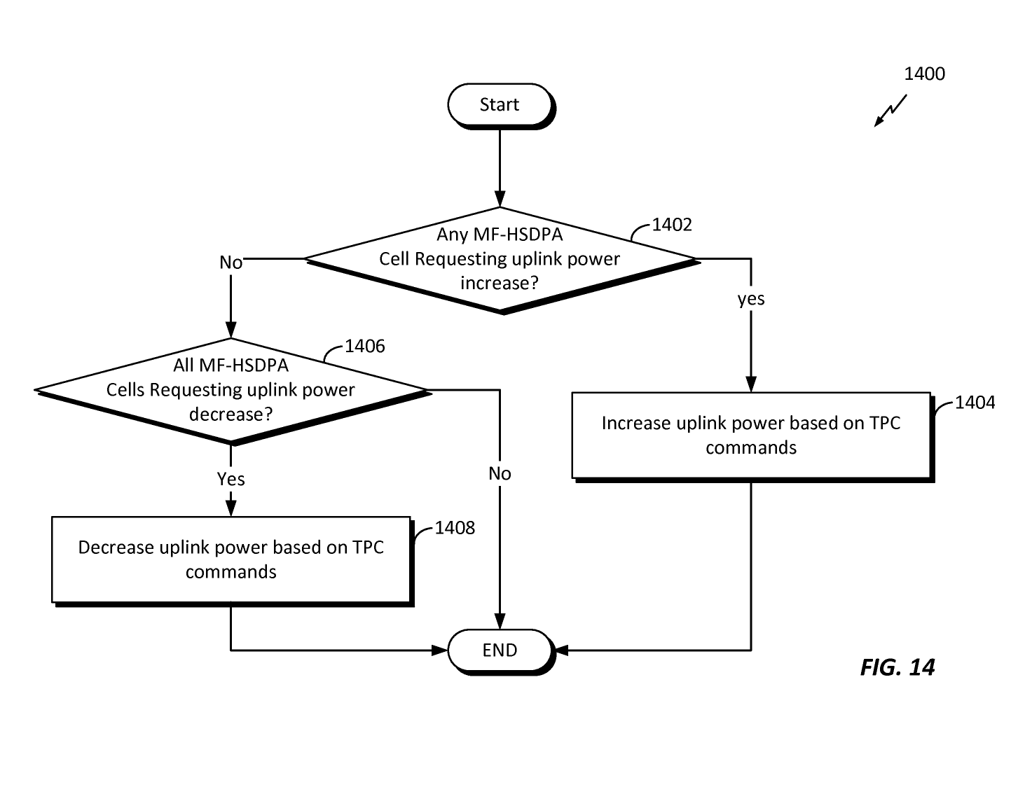

At block 506, if the imbalance condition exists, the UE determines a transmit power 610 for the UE that is less than a transmit power requested by the HS cell and more than the OOD transmit power 604. As a result, the UE may favor the transmit power command of the HS cell over that of the non-HS cells. For example, in an aspect of the disclosure, the transmit power determining component includes an HS-only slots determining component 612 that determines a number or percentage of HS-only slots 614 (e.g., time slots 508 of FIG. 5) to listen only to HS cell(s). In other time slots (e.g., time slot 510 of FIG. 5), the UE may listen to the power control commands of both the HS cells and non-HS cells. In some aspects of the disclosure, the amount of HS-only slots 614 utilized by the UE may be determined based on at least one of a number or percentage of duplicate downlink packets (DUPs), an SRB traffic expectation, an HS downlink scheduling number or percentage, a number or percentage of power down commands from the HS cell and non-HS cells, and an absolute maximum transmit power of the UE. In an aspect of the disclosure, when more traffic is expected from the HS cell, the percentage of HS-only slots 614 may be higher than when less traffic is expected from the HS cell. In one aspect of the disclosure, traffic expectation can be a function of application layer determination (e.g., traffic may be expected if UE initiates an FTP or a video chat). In another aspect of the disclosure, traffic expectation can be a function of physical layer determination (e.g., expect more traffic if there is data traffic in the recent past). The various components of the UE 600 of FIG. 6 may be implemented as software, hardware, and a combination of hardware and software such as the apparatus 100 of FIG. 1. Some other components of the UE 600 will be described in relation to FIGS. 13 and 14 below.

In Release 5 HSDPA, at any instance a UE has one serving cell: the strongest cell in the active set as according to the UE measurements of E_{c}/I₀. According to mobility procedures defined in Release 5 of 3GPP Technical Specification (TS) 25.331, the radio resource control (RRC) signaling messages for changing the HSPDA serving cell are transmitted from the current HSDPA serving cell (i.e., the source cell) and not the cell that the UE reports as being the stronger cell (i.e., the target cell).

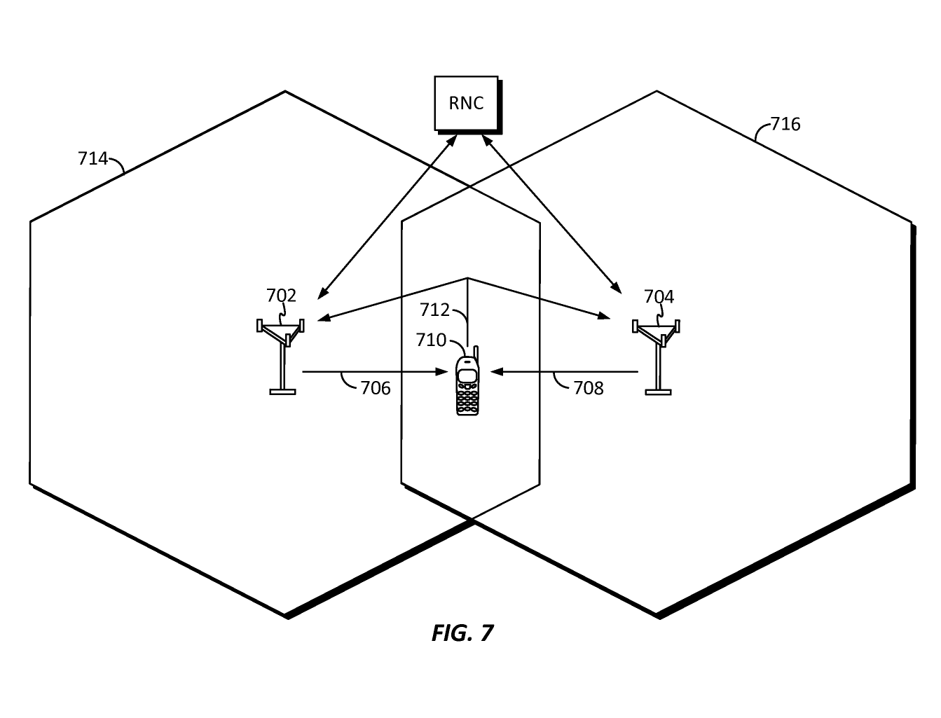

A form of aggregation, which may be referred to as soft aggregation, provides for downlink aggregation wherein the respective downlink cells utilize the same frequency carrier. FIG. 7 illustrates an exemplary system for soft aggregation in accordance with some aspects of the present disclosure. In FIG. 7, there may be a geographic overlap between two or more cells 714 and 716, such that a UE 710 may be served, at least for a certain period of time, by the multiple cells. Although not shown in FIG. 7, it should be understood that the UE 710 may be within the coverage area of one or more non-HS cells. For example, the UE 710 can also be in soft handover with one or more UMTS Release 99 cells at the same time as it is in MF-HSDPA operation. Here, referring again to FIGS. 2 and 4, the UE 710 is one example of a UE 210 that may be utilized in a UMTS system 200 in accordance with some aspects of the present disclosure. That is, a wireless telecommunication system in accordance with the present disclosure may provide HSDPA service from a plurality of cells on a single frequency channel, such that a UE 710 may perform link aggregation. Here, the UE 710 may aggregate downlinks from a primary serving cell and at least one secondary serving cell. For example, a setup utilizing two or more cells may be referred to as Multi-flow HSDPA (MF-HSDPA), coordinated multi-point HSDPA (CoMP HSDPA), or simply multipoint HSDPA. One particular configuration of a Multi-flow HSDPA system that utilizes two cells is sometimes referred to as single frequency dual cell HSDPA (SF-DC-HSDPA). However, other terminology may freely be utilized. In this example, users at cell boundaries, as well as the overall system, may benefit from a high throughput. In various examples, the different cells may be provided by the same Node B or the different cells may be provided by separate Node Bs.

In the MF-HSDPA scheme illustrated in FIG. 7, two Node Bs 702 and 704 each provide downlink channels 706 and 708, respectively, wherein the downlink channels are in substantially the same carrier frequency. In another example, both downlink channels 706 and 708 may be provided from different sectors of the same Node B. The UE 710 receives and aggregates the downlink channels (706 and 708) and provides an uplink channel 712, which may be received by one or both Node Bs 702 and 704. The uplink channel 712 from the UE 710 may provide feedback information (e.g., corresponding to the downlink channel state) for the corresponding downlink channels 706 and 708. The UE 710 may have one or more receive chains, each of which may be used to receive High Speed (HS) data from a different cell.

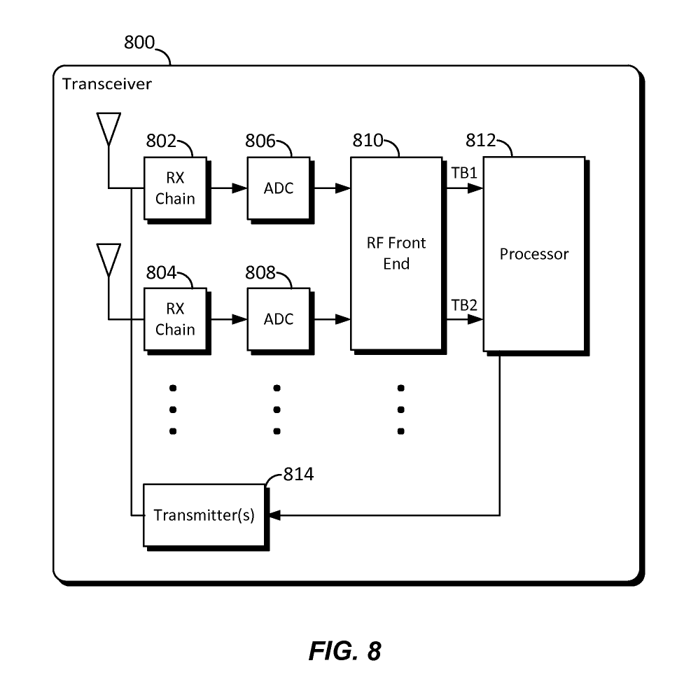

FIG. 8 is a simplified block diagram illustrating some components of an exemplary transceiver 800 for a UE in accordance with some aspects of the present disclosure. In some aspects of the disclosure, the transceiver 800 may be the same as the transceiver 110 shown in FIG. 1 for transmitting and receiving data using MF-HSDPA. In the illustration, the transceiver 800 includes two receive chains 802 and 804 for receiving respective downlink signals in the same carrier frequency, as in a MF-HSDPA network. However, within the scope of the present disclosure, the transceiver 800 may include any suitable number of receive chains for receiving downlink signals in the same carrier frequency or in any suitable number of different carrier frequencies.

Coupled to the receive chains 802 and 804 may be respective analog to digital converters 806 and 808, which may transform the received downlink channels to the digital domain to be further processed by an RF front end 810. The RF front end 810 may then provide the received transport blocks to a processor 812 to be further processed in accordance with the received information. In an aspect of the disclosure, the processor 812 may be the same as the processor 104 of FIG. 1. The processor 812 may additionally be coupled to one or more transmitters 814, which may utilize one or more of the UE's antennas as managed by a suitable duplexer.

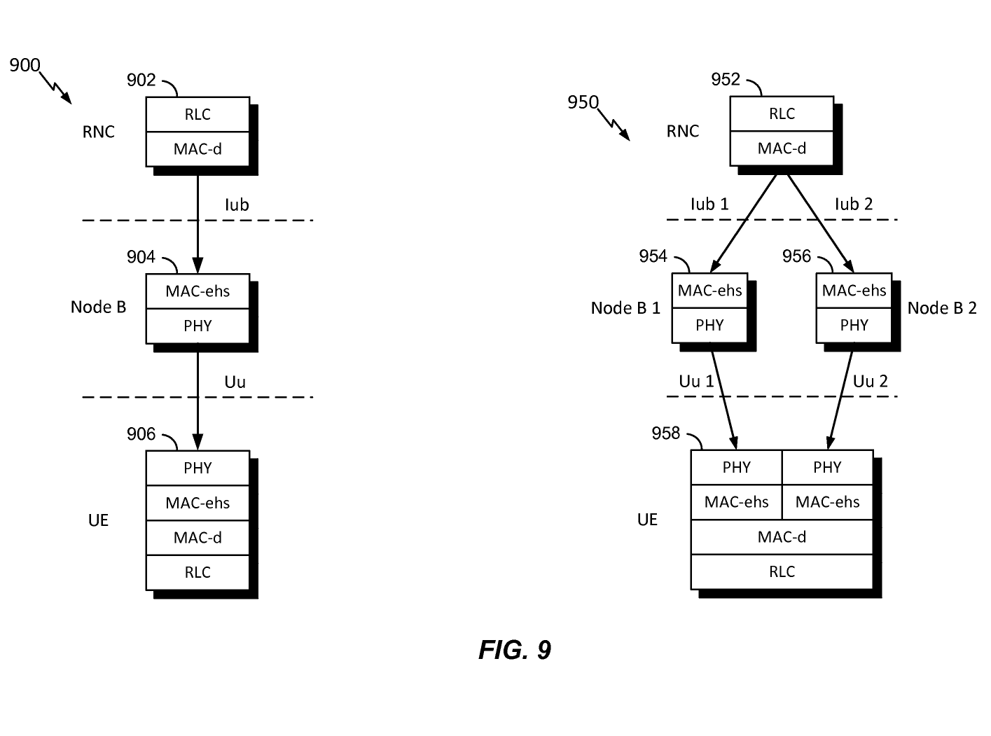

FIG. 9 is a schematic illustration comparing downlink paths in an HSDPA network 900 and a MF-HSDPA network 950. The MF-HSDPA network 950 may be the same as the system configured for soft aggregation and illustrated in FIG. 7. In the HSDPA network 900, a downlink path between an RNC 902 and a UE 906 passes through a Node B 904. Here, the RNC 902 houses protocol layers from the MAC layer and above, including, for example, the RLC sublayer. For the high-speed downlink channels, a MAC layer also resides at the Node B 904. Further, a PHY layer at the Node B 904 provides an air interface for communicating with a corresponding PHY layer at the UE 906 (e.g., over an HS-DSCH).

From the UE 906 side, a MAC entity is configured to control access to the dedicated transport channels, to handle the HSDPA-specific functions, and to control access to the HS-DSCH transport channel. Upper layers within the UE 906 may configure which of two different MAC entities, a MAC-hs or a MAC-ehs, is to be applied to handle HS-DSCH functionality.

On the other hand, in the MF-HSDPA network 950, an RNC 952 may provide packets from an RLC flow to a plurality of Node Bs 954 and 956, each providing respective downlink HS-transmissions to a UE 958. Thus, the RNC 952 may include a multi-link RLC sublayer, wherein a flow control algorithm may allocate packets from an RLC flow for the UE 958 among the plurality of cells (e.g., at Node Bs 954 and 956) utilizing respective Iub interfaces. Of course, the multi-link RLC implementation is only one example of a MF-HSDPA system, provided herein only for clarity of explanation. Those of ordinary skill in the art will understand that other implementations of downlink carrier aggregation may be utilized within the scope of the present disclosure. For example, the UE 958 may be any of the UEs shown in FIGS. 2, 4, and 6-7.

Here, the UE 958 may include a plurality of MAC entities, each of the plurality of MAC entities corresponding to a different serving cell (e.g., a primary serving cell and a secondary serving cell) from corresponding Node B sites. For example, a first MAC entity in the UE 958 may correspond to the first Node B 954 providing a primary serving cell, and a second MAC entity in the UE 958 may correspond to the second Node B 956 providing a secondary serving cell. Of course, for various reasons, the pairing of a particular MAC entity with a particular Node B may change over time and the illustration is only one possible example.

FIG. 10 is a block diagram of an exemplary Node B 1010 in communication with an exemplary UE 1050, where the Node B 1010 may be any of the Node Bs in FIGS. 2 and 4, and the UE 1050 may be any of the UEs illustrated in FIGS. 2, 4, 6 and 7. While the UE 1050 may have multiple receive chains for supporting MF-HSDPA, only a single receive chain is shown in FIG. 10 for clarity. However, the present invention is not limited to the particular example of FIG. 10. In the downlink communication, a transmit processor 1020 may receive data from a data source 1012 and control signals from a controller/processor 1040. The transmit processor 1020 provides various signal processing functions for the data and control signals, as well as reference signals (e.g., pilot signals). For example, the transmit processor 1020 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1044 may be used by a controller/processor 1040 to determine the coding, modulation, spreading, and/or scrambling schemes for the transmit processor 1020. These channel estimates may be derived from a reference signal transmitted by the UE 1050 or from feedback from the UE 1050. The symbols generated by the transmit processor 1020 are provided to a transmit frame processor 1030 to create a frame structure. The transmit frame processor 1030 creates this frame structure by multiplexing the symbols with information from the controller/processor 1040, resulting in a series of frames. The frames are then provided to a transmitter 1032, which provides various signal conditioning functions including amplifying, filtering, and modulating the frames onto a carrier for downlink transmission over the wireless medium through antenna 1034. The antenna 1034 may include one or more antennas, for example, including beam steering bidirectional adaptive antenna arrays or other similar beam technologies.

At the UE 1050, a receiver 1054 receives the downlink transmission through an antenna 1052 and processes the transmission to recover the information modulated onto the carrier. The information recovered by the receiver 1054 is provided to a receive frame processor 1060, which parses each frame, and provides information from the frames to a channel processor 1094 and the data, control, and reference signals to a receive processor 1070. The receive processor 1070 then performs the inverse of the processing performed by the transmit processor 1020 in the Node B 1010. More specifically, the receive processor 1070 descrambles and despreads the symbols, and then determines the most likely signal constellation points transmitted by the Node B 1010 based on the modulation scheme. These soft decisions may be based on channel estimates computed by the channel processor 1094. The soft decisions are then decoded and deinterleaved to recover the data, control, and reference signals. The CRC codes are then checked to determine whether the frames were successfully decoded. The data carried by the successfully decoded frames will then be provided to a data sink 1072, which represents applications running in the UE 1050 and/or various user interfaces (e.g., display). Control signals carried by successfully decoded frames will be provided to a controller/processor 1090. When frames are unsuccessfully decoded by the receiver processor 1070, the controller/processor 1090 may also use an acknowledgement (ACK) and/or negative acknowledgement (NACK) protocol to support retransmission requests for those frames.

In the uplink, data from a data source 1078 and control signals from the controller/processor 1090 are provided to a transmit processor 1080. The data source 1078 may represent applications running in the UE 1050 and various user interfaces (e.g., keyboard). Similar to the functionality described in connection with the downlink transmission by the Node B 1010, the transmit processor 1080 provides various signal processing functions including CRC codes, coding and interleaving to facilitate FEC, mapping to signal constellations, spreading with OVSFs, and scrambling to produce a series of symbols. Channel estimates, derived by the channel processor 1094 from a reference signal transmitted by the Node B 1010 or from feedback contained in the midamble transmitted by the Node B 1010, may be used to select the appropriate coding, modulation, spreading, and/or scrambling schemes. The symbols produced by the transmit processor 1080 will be provided to a transmit frame processor 1082 to create a frame structure. The transmit frame processor 1082 creates this frame structure by multiplexing the symbols with information from the controller/processor 1090, resulting in a series of frames. The frames are then provided to a transmitter 1056, which provides various signal conditioning functions including amplification, filtering, and modulating the frames onto a carrier for uplink transmission over the wireless medium through the antenna 1052.

The uplink transmission is processed at the Node B 1010 in a manner similar to that described in connection with the receiver function at the UE 1050. A receiver 1035 receives the uplink transmission through the antenna 1034 and processes the transmission to recover the information modulated onto the carrier. The information recovered by the receiver 1035 is provided to a receive frame processor 1036, which parses each frame, and provides information from the frames to the channel processor 1044 and the data, control, and reference signals to a receive processor 1038. The receive processor 1038 performs the inverse of the processing performed by the transmit processor 1080 in the UE 1050. The data and control signals carried by the successfully decoded frames may then be provided to a data sink 1039 and the controller/processor, respectively. If some of the frames were unsuccessfully decoded by the receive processor, the controller/processor 1040 may also use an acknowledgement (ACK) and/or negative acknowledgement (NACK) protocol to support retransmission requests for those frames.

The controller/processors 1040 and 1090 may be used to direct the operation at the Node B 1010 and the UE 1050, respectively. For example, the controller/processors 1040 and 1090 may provide various functions including timing, peripheral interfaces, voltage regulation, power management, and other control functions. The computer readable media of memories 1042 and 1092 may store data and software for the Node B 1010 and the UE 1050, respectively. A scheduler/processor 1046 at the Node B 1010 may be used to allocate resources to the UEs and schedule downlink and/or uplink transmissions for the UEs.

In MF-HSDPA scenarios, an HS link is established with multiple cells (e.g., cells 714 and 716 of FIG. 7) on the same carrier frequency. The maximum supported downlink data rate from each HS flow is a function of the channel quality reported from each cell. The uplink HS-DPCCH contains ACK/NACK feedback information for each HS flow as well as the downlink channel quality indicator (CQI) information for each link. Each cell decodes the ACK/NACK and CQI independently in their processing. The ACK/NACK transmission reflects the results of the CRC check after the packet decoding and combining. The downlink CQI indicates which estimated transport block size, modulation type and number of parallel codes could be received correctly (with reasonable block error rate (BLER)) in the downlink direction.

One aspect of any wireless communication network is power control of uplink transmission power. In the uplink, the transmission power of the UEs determines the amount of interference to the adjacent cells, and the received power determines the amount of interference to other UEs in the same cell. In a UMTS network utilizing W-CDMA, an inner loop power control and an outer loop power control work together to manage uplink transmission power. Inner loop power control, also frequently referred to as fast power control, includes the determination of a signal-to-interference ratio (SIR) at the Node B (e.g., Node B 208), and if the estimated SIR is above a target SIR, the Node B may transmit a transmit power control (TPC) command to the UEs (e.g., UE 210) that have that Node B in their Active Set, requesting those UEs to lower their transmission power. Outer loop power control includes the determination of uplink quality at the RNC, and based on the determined quality, the target SIR (used by inner loop power control) is sent to the Node Bs. Thus, the target SIR can go up and down over time, in accordance with one or more characteristics of the uplink quality, e.g., the uplink packet error rates.

In an HSDPA network, the uplink transmission power of the HS-DPCCH is determined relative to the power level on the DPCCH. That is, an offset relative to the DPCCH power is utilized by the UE to determine the power for transmission of the HS-DPCCH. This offset can be referred to as a control-to-power offset (C2P), and is generally one selected from three different offsets: a Delta_ACK, a Delta NACK, or a Delta_CQI. That is, depending on which information element is being transmitted on the HS-DPCCH, one of these offsets may be selected to be the C2P for an uplink transmission. Here, various issues may arise corresponding to the setting of the transmission power of the HS-DPCCH. For example, the HS-DPCCH utilizes a portion of the uplink transmission power, and therefore, setting the power too high can impact the link budget for other uplink transmissions from the UE. Similarly, setting the power too high can cause a potentially unnecessary noise rise, interfering with uplink transmissions from other UEs, which may be located in the same cell or nearby non-HS cells. On the other hand, setting the HS-DPCCH power too low can affect HSDPA performance if the transmissions are not properly received at the Node B.

In a non-multi-flow HSDPA configuration, each of the Node Bs in the active set sends an independent power control command to the UE to control the uplink transmission power. Therefore, the UE will lower its transmission power if any of the Node Bs sends a power-down command to the UE. This control scheme may be referred to as the OOD power-down control approach as described above. In MF-HSDPA configuration, the serving cells (e.g., Node Bs 702 and 704 of FIG. 7) each generate TPC commands (TPC_cmd) and transmit the commands to a UE (e.g., UE 710) by different flows (e.g., by channels 706 and 708 of FIG. 7). Upon reception of one or more TPC commands in a slot, the UE derives a single TPC command for each slot, combining multiple TPC commands if more than one is received in a slot. Each Node B may transmit the TPC commands to the UE by a downlink (DL) dedicated physical channel (DPCH). Referring to FIG. 11, a dedicated physical data channel (DPDCH) and a dedicated physical control channel (DPCCH) are time-multiplexed onto a DL DPCH 1100. The DPCCH includes transmit power control (TPC) bits 1102 that carry the power control commands to the UE for uplink power control. A fractional DPCH (F-DPCH) 1104 is implemented by giving each participating UE an offset on the DL DPCH channel where it could listen for its TPC command 1106. The UE sleeps for the rest of the time on that channelization code and wakes up at the assigned instance to get its TPC command.

In MF-HSDPA, the uplink 712 (e.g., HS-DPCCH) from the UE 710 is received by both Node Bs 702 and 704. Depending on various conditions, the uplink power reaching the Node Bs may be imbalanced. When there is significant imbalance between the UL power desired from each HS uplink on different TPC groups, the network might not be able to decode the ACK/NACK feedback reliably from the weaker uplink if the OOD control approach is used. In the OOD power control scheme, the UE 710 will perform a power control algorithm that decreases the uplink transmit power when any of the Node Bs transmits a TPC command to the UE requesting reduction of its uplink power. However, such power control approach may not be desirable in a multi-flow configuration because when the UE 710 reduces its uplink power in accordance with the OOD approach, while a multi-flow cell (e.g., Node B 702) receiving the stronger uplink can still receive the uplink transmission at the reduced uplink power, another multi-flow cell (e.g., Node B 704) that was receiving an already weak uplink transmission might not be able to decode the ACK/NACK feedback reliably from the weaker link at further reduced power. This can cause a reduction in the gains from enabling MF-HSDPA because the weaker link will likely be sending many duplicate packets to the UE, and may not have an accurate reading of the CQI from the UE for scheduling purposes. This issue can also greatly reduce the gains from network traffic balancing with MF-HSDPA. Although the UE may increase the HS-DPCCH power globally when MF-HSDPA is enabled, this may reduce spectral efficiency on uplink.

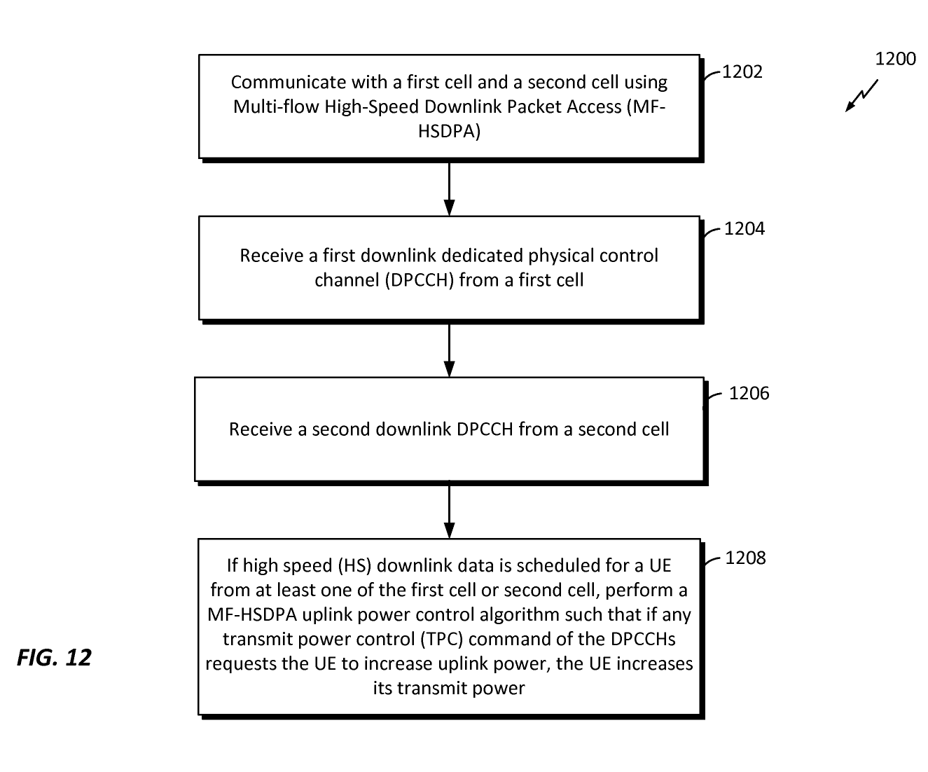

In various aspects of the present disclosure, a UE may use a power control scheme, which is different from the OOD approach, to increase uplink power when more power is needed for reliable HS-DPCCH performance in a MF-HSDPA network. FIG. 12 is a flowchart illustrating a method 1200 for controlling uplink power of a UE in MF-HSDPA operation. In various aspects of the disclosure, the method 1200 may be performed by any of the UEs illustrated in FIGS. 2, 4, 6, 7, and 10 in MF-HSDPA operation.

At block 1202, the UE communicates with a first cell and a second cell using MF-HSDPA. In an aspect of the disclosure, the first cell and second cell may be the cells 714 and 716 of FIG. 7. At block 1204, the UE receives a first downlink dedicated physical control channel (DPCCH) from the first cell. For example, the first DPCCH may be the downlink channel 706 in FIG. 7. At block 1206, the UE receives a second downlink DPCCH channel from the second cell. For example, the second DPCCH may be the downlink channel 708 in FIG. 7. At block 1208, if HS downlink data is scheduled for the UE from at least one of the first cell or second cell, the UE performs a MF-HSDPA uplink power control algorithm in which if any transmit power control (TPC) command of the first and second DPCCH channels direct the UE to increase uplink power, the UE may increase its transmit power in certain conditions, which will be described in more detail in relation to FIGS. 13-15. In various aspects of the disclosure, the method 1200 may be performed based on the algorithms 1300 and 1400 of FIGS. 13 and 14 such that MF-HSDPA uplink power control at the UE may be improved.

FIGS. 13 and 14 are flowcharts illustrating a MF-HSDPA uplink power control algorithm 1300 in accordance with an aspect of the disclosure. In an aspect of the disclosure, the algorithm 1300 may be performed by a UE 600 of FIG. 6, which may be any of the UEs illustrated in FIGS. 2, 4, 7, and 10, and may be implemented using the apparatus 100 of FIG. 1. In other aspects of the disclosure, the algorithm 1300 may be performed by any suitable UE operating in a MF-HSDPA network. This power control algorithm 1300 may be applicable for cells with HS enabled. In one aspect of the disclosure, an HS enabled cell refers to a scenario in which the UE is in an HSDPA call with the cell. The UE monitors an HS-SCCH from an “HS enabled” cell and reports CQI for the cell. The UE may or may not continuously receive HSDPA data (HS-PDSCH/HS-SCCH) from such cell. Before the introduction of MF-HSPDA, HS can be enabled for only one cell per carrier, but with MF-HSDPA, HS can be enabled for multiple cells per carrier.

At block 1302, a UE 600 receives one or more TPC commands from MF-HSDPA cells. For example, in one aspect of the disclosure, the MF-HSDPA cells may be cells 714 and 716 that are respectively associated with Node Bs 702 and 704. The UE 600 may have a TPC commands handling component 622 for receiving and processing the TPC commands from the MF-HSDPA cells. If it is determined that active HS downlink scheduling is present, the procedure 1300 continues to block 1306; otherwise, the procedure 1300 continues to block 1304. Active HS downlink scheduling is present when high speed (HS) downlink data (e.g., HSDPA data) from at least one of the MF-HSDPA cells is scheduled for the UE 600. For example, the UE 600 may have an active HS scheduling determining component 624 for determining whether or not active HS downlink scheduling is present. In one aspect of the disclosure, active HS downlink scheduling is present when the UE is in an HSDPA call with a cell, and HSDPA data is scheduled to the UE (i.e., HS-SCCH and HS-PDSCH contain data intended for the UE). The UE monitors the HS-SCCH, and if HS-SCCH passes a cyclic redundancy check (CRC), then the UE interprets this as “HSDPA data” scheduled for the UE. In an aspect of the disclosure, the presence of HS downlink data may be determined by checking the active HS downlink (DL) scheduling within the past N downlink subframes (e.g., a predetermined number of subframes). In an aspect of the disclosure, the value of N (e.g., 6 or 12 subframes) can be chosen to cover one or two HARQ retransmission time intervals (or longer/shorter depending on other design considerations).

In another aspect of the disclosure, active HS scheduling may be detected on a flow if there has been presence of HS data in X out of last Y subframes. For example, active HS scheduling is detected if HS data is present in 15 out of last 100 subframes. In still another aspect of the disclosure, active HS scheduling may be detected on a flow if there is uplink activity because of which downlink (DL) activity is expected. This DL activity may be considered to be in “Active HS” mode for both flows for the next K subframes (e.g., K may be any suitable non-zero integer). Example of such UL activity may be that the UE has sent network an RLC PDU, and the RLC ACK is pending in the DL.

When no cell in communication with the UE has recent HS DL data scheduled for the UE, the UE performs the OOD uplink power control as described above at block 1304 of FIG. 13. For example, the UE 600 has an OOD transmit power determining component 602 that decreases uplink transmit power when any of the Node Bs or cells transmits a TPC command instructing the UE to reduce its uplink power. In one aspect of the disclosure, the uplink power of the UE may be controlled in accordance with the uplink transmit power determination method 500 as described in FIG. 5. At block 1306, the UE performs a novel MF-HSDPA uplink power control algorithm that will be described in more detail in relation to FIG. 14. In one aspect of the disclosure, the UE 600 has a MF-HSDPA uplink power control component 628 for controlling the uplink power based on an OR-power up approach, which will be described in detail in relation to FIG. 14 below.

FIG. 14 is a flowchart illustrating a MF-HSDPA uplink power control algorithm 1400 according to one aspect of the disclosure, which may be performed in block 1306 of FIG. 13. At block 1402, if any of the MF-HSDPA cells requests the UE to increase uplink power, the algorithm 1400 proceeds to block 1404; otherwise, it proceeds to block 1406. At block 1404, the UE increases its uplink power based on the received TPC commands (OR-power up approach). In one aspect of the disclosure, for example, if active HS downlink scheduling is present on both flows respectively from MF-HSDPA cells 714 and 716 (see FIG. 7), the UE controls its uplink power based on the Or-power up approach for the TPC commands received from both flows. In another aspect of the disclosure, if active HS downlink scheduling is present on the flow from only one MF-HSDPA cell 714 or 716, the UE controls its uplink power based on the TPC commands received only from that flow with active HS data scheduled.

At block 1406, if all of the MF-HSDPA cells request the UE to decrease uplink power, the UE decreases its uplink power based on the received TPC commands at block 1408. In one aspect of the disclosure, the algorithm 1400 may be performed utilizing the MF-HSDPA uplink power control component 628 (see FIG. 6). With this MF-HSDPA power control algorithm 1400, as soon as HS DL scheduling occurs on one of the HS cells, the uplink power can change such that the UL will be transmitting at a level that this Node B can understand the UL feedback. If there is insufficient time for UL to come up to the necessary level for the first valid ACK/NACK feedback, then by the next HARQ re-transmission, the UL transmission would have had much more time to get up to a sufficient power level. The various components of the UE 600 may be software, hardware, or a combination of hardware or software. For example, in an aspect of the disclosure, the UE 600 includes transmit power determining software 630 that when executed configures the various components of the UE to perform the above-described functions and algorithms.

In some aspects of the disclosure, the method for uplink transmit power determination in soft handover illustrated in FIGS. 5-6 and the power control method for controlling uplink power at a UE in a MF-HSDPA network may be performed by the same UE. In some aspects of the disclosure, a UE may include some or all of the components described in relation to FIG. 6.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of controlling uplink power of a user equipment (UE) in a wireless communication system, comprising:
communicating with a first cell and a second cell using Multi-flow High-Speed Downlink Packet Access (MF-HSDPA);
receiving a first downlink dedicated physical control channel (DPCCH) from the first cell;
receiving a second downlink DPCCH from the second cell; and
if high speed (HS) downlink data is scheduled for the UE from at least one of the first cell or second cell, performing a MF-HSDPA uplink power control algorithm comprising:
if a transmit power control (TPC) command of the first or second downlink DPCCHs requests the UE to increase uplink power, increasing the transmit power of the UE.

2. The method of claim 1, further comprising:
receiving a first HS flow from the first cell and a second HS flow from the second cell; and
determining the presence of HS downlink data scheduled for the UE based on High-Speed Downlink Packet Access (HSDPA) data scheduled for the UE on at least one of the first HS flow or second HS flow.

3. The method of claim 2, wherein determining the presence of HS downlink data scheduled for the UE comprises:
monitoring a high-speed shared control channel (HS-SCCH); and
if the HS-SCCH passes a cyclic redundancy check, determining that HSDPA data is scheduled for the UE.

4. The method of claim 2, further comprising determining the presence of HS downlink data scheduled for the UE during a predetermined number of past downlink subframes.

5. The method of claim 4, wherein the predetermined number of past downlink subframes correspond to one or more hybrid automatic repeat request (HARQ) retransmission time intervals.

6. The method of claim 1, further comprising:
receiving a first HS flow from the first cell and a second HS flow from the second cell; and
if HS downlink data is not scheduled with both the first and second HS flows, performing an or-of-downs (OOD) uplink power control algorithm,
wherein the OOD uplink power control algorithm comprises:
if a TPC command of the DPCCHs requests the UE to reduce uplink power, reducing the transmit power of the UE.

7. The method of claim 1, further comprising:
receiving one or more TPC commands from a third cell and one of the first and second cells, wherein the one of the first and second cells is a HS cell and the third cell is a non-HS cell;
determining an or-of-downs (OOD) transmit power based on the one or more TPC commands;
determining an imbalance condition based on the one or more TPC commands; and
if the imbalance condition exists, determining a transmit power that is less than a transmit power requested by the HS cell and more than the OOD transmit power.

8. The method of claim 7, further comprising:
determining a number of first time slots for listening to TPC commands only from the HS cell; and
determining a number of second time slots for listening to TPC commands from both the HS cell and non-HS cell.

9. The method of claim 8, wherein the number of first time slots is determined based on at least one of:
a number or percentage of duplicate downlink packets;
a signaling radio bearer (SRB) traffic expectation;
an HS downlink scheduling number or percentage;
a number or percentage of power down commands from the HS cell and non-HS cells; or
an absolute maximum transmit power of the UE.

10. The method of claim 8, further comprising:
if more traffic is expected from the HS cell, increasing the number of first time slots; and
if less traffic is expected from the HS cell, decreasing the number of first time slots.

11. An apparatus for wireless communication, comprising:
at least one processor;
a communication interface coupled to the at least one processor; and
a memory coupled to the at least one processor, wherein the at least one processor comprises:
a first component configured to communicate with a first cell and a second cell using Multi-flow High-Speed Downlink Packet Access (MF-HSDPA),
a second component configured to:
receive a first downlink dedicated physical control channel (DPCCH) from the first cell; and
receive a second downlink DPCCH from the second cell; and
a third component configured to if high speed (HS) downlink data is scheduled for the apparatus from at least one of the first cell or second cell, perform a MF-HSDPA uplink power control algorithm comprising:
if a transmit power control (TPC) command of the first or second downlink DPCCHs requests the apparatus to increase uplink power, increasing the transmit power of the apparatus.

12. The apparatus of claim 11, further comprising a fourth component configured to:
receive a first HS flow from the first cell and a second HS flow from the second cell; and
determine the presence of HS downlink data scheduled for the apparatus based on High-Speed Downlink Packet Access (HSDPA) data scheduled for the apparatus on at least one of the first HS flow or second HS flow.

13. The apparatus of claim 12, wherein for determining the presence of HS downlink data scheduled for the apparatus, the fourth component is further configured to:
monitor a high-speed shared control channel (HS-SCCH); and
if the HS-SCCH passes a cyclic redundancy check, determine that HSDPA data is scheduled for the apparatus.

14. The apparatus of claim 12, wherein the fourth component is further configured to:
determine the presence of HS downlink data scheduled for the apparatus during a predetermined number of past downlink subframes.

15. The apparatus of claim 14, wherein the predetermined number of past downlink subframes correspond to one or more hybrid automatic repeat request (HARQ) retransmission time intervals.

16. The apparatus of claim 11, further comprising a fourth component configured to:
receive a first HS flow from the first cell and a second HS flow from the second cell; and
if HS downlink data is not scheduled with both the first and second HS flows, perform an or-of-downs (OOD) uplink power control algorithm,
wherein the OOD uplink power control algorithm comprises:
if a TPC command of the DPCCHs requests the apparatus to reduce uplink power, reduce the transmit power of the apparatus.

17. The apparatus of claim 11, further comprising a fourth component configured to:
receive one or more TPC commands from a third cell and one of the first and second cells, wherein the one of the first and second cells is HS cell and the third cell is a non-HS cell;
determine an or-of-downs (OOD) transmit power based on the one or more TPC commands;
determine an imbalance condition based on the one or more TPC commands; and
if the imbalance condition exists, determine a transmit power that is less than a transmit power requested by the HS cell and more than the OOD transmit power.

18. The apparatus of claim 17, wherein the fourth component is further configured to:
determine a number of first time slots for listening to TPC commands only from the HS cell; and
determine a number of second time slots for listening to TPC commands from both the HS cell and non-HS cell.

19. The apparatus of claim 18, wherein the number of first time slots is determined based on at least one of:
a number or percentage of duplicate downlink packets;
a signaling radio bearer (SRB) traffic expectation;
an HS downlink scheduling number or percentage;
a number or percentage of power down commands from the HS cell and non-HS cells; or
an absolute maximum transmit power of the apparatus.

20. The apparatus of claim 18, wherein the fourth component is further configured to:
if more traffic is expected from the HS cell, increase the number of first time slots; and
if less traffic is expected from the HS cell, decrease the number of first time slots.

21. An apparatus for wireless communication, comprising:
means for communicating with a first cell and a second cell using Multi-flow High-Speed Downlink Packet Access (MF-HSDPA);
means for receiving a first downlink dedicated physical control channel (DPCCH) from the first cell;
means for receiving a second downlink DPCCH from the second cell; and
means for if high speed (HS) downlink data is scheduled for the apparatus from at least one of the first cell or second cell, performing a MF-HSDPA uplink power control algorithm comprising:
if a transmit power control (TPC) command of the first or second downlink DPCCHs requests the apparatus to increase uplink power, increasing the transmit power of the apparatus.

22. The apparatus of claim 21, further comprising:
means for receiving a first HS flow from the first cell and a second HS flow from the second cell; and
means for determining the presence of HS downlink data scheduled for the apparatus based on High-Speed Downlink Packet Access (HSDPA) data scheduled for the apparatus on at least one of the first HS flow or second HS flow.

23. The apparatus of claim 22, wherein the means for determining the presence of HS downlink data scheduled for the apparatus is configured to:
monitor a high-speed shared control channel (HS-SCCH); and
if the HS-SCCH passes a cyclic redundancy check, determine that HSDPA data is scheduled for the apparatus.

24. The apparatus of claim 22, further comprising means for determining the presence of HS downlink data scheduled for the apparatus during a predetermined number of past downlink subframes.

25. The apparatus of claim 24, wherein the predetermined number of past downlink subframes correspond to one or more hybrid automatic repeat request (HARQ) retransmission time intervals.

26. The apparatus of claim 21, further comprising:
means for receiving a first HS flow from the first cell and a second HS flow from the second cell; and
means for if HS downlink data is not scheduled with both the first and second HS flows, performing an or-of-downs (OOD) uplink power control algorithm,
wherein the OOD uplink power control algorithm comprises:
if a TPC command of the DPCCHs requests the apparatus to reduce uplink power, reducing the transmit power of the UE.

27. The apparatus of claim 21, further comprising:
means for receiving one or more TPC commands from a third cell and one of the first and second cells, wherein the one of the first and second cells is a HS cell and the third cell is a non-HS cell;
means for determining an or-of-downs (OOD) transmit power based on the one or more TPC commands;
means for determining an imbalance condition based on the one or more TPC commands; and
means for if the imbalance condition exists, determining a transmit power that is less than a transmit power requested by the HS cell and more than the OOD transmit power.

28. The apparatus of claim 27, further comprising:
means for determining a number of first time slots for listening to TPC commands only from the HS cell; and
means for determining a number of second time slots for listening to TPC commands from both the HS cell and non-HS cell.

29. The apparatus of claim 28, wherein the number of first time slots is determined based on at least one of:
a number or percentage of duplicate downlink packets;
a signaling radio bearer (SRB) traffic expectation;
an HS downlink scheduling number or percentage;
a number or percentage of power down commands from the HS cell and non-HS cells; or
an absolute maximum transmit power of the apparatus.

30. A computer-readable storage medium comprising code for controlling uplink power of a user equipment (UE) in a wireless communication system, the code causing the UE to:
communicate with a first cell and a second cell using Multi-flow High-Speed Downlink Packet Access (MF-HSDPA);
receive a first downlink dedicated physical control channel (DPCCH) from the first cell;
receive a second downlink DPCCH from the second cell; and
if high speed (HS) downlink data is scheduled for the UE from at least one of the first cell or second cell, perform a MF-HSDPA uplink power control algorithm comprising:
if a transmit power control (TPC) command of the first or second downlink DPCCHs requests the UE to increase uplink power, increasing the transmit power of the UE.
